(19) United States
(12) Patent Application Publication
(10) Pub. No.: US 2019/0089923 A1
(43) Pub. Date: Mar. 21, 2019

(54) VIDEO PROCESSING APPARATUS FOR DISPLAYING A PLURALITY OF VIDEO IMAGES IN SUPERIMPOSED MANNER AND METHOD THEREOF

(71) Applicant: CANON KABUSHIKI KAISHA, Tokyo (JP)

(72) Inventors: Yasuo Katano, Kawasaki-shi (JP); Katsuhiko Mori, Kawasaki-shi (JP)

(21) Appl. No.: 16/134,205

(22) Filed: Sep. 18, 2018

(30) Foreign Application Priority Data
Sep. 21, 2017 (JP) 2017-181387

(51) Int. Cl. H04N 5/445; H04N 5/265; H04N 5/262; G06T 7/50; G06T 7/20; G06T 7/70; G06K 9/00

(52) U.S. Cl. CPC H04N 5/44504; H04N 5/265; H04N 5/2625; G06T 7/50; G06T 7/20; G06T 2207/20212; G06K 9/00711; G06K 9/00744; G06T 2207/10016; G06T 2207/30228; G06T 7/70

(57) ABSTRACT

A video processing apparatus includes an acquisition unit configured to acquire a video image, an object extraction unit configured to extract a plurality of predetermined objects from the video image, a selection unit configured to select a target object to be an observation target from the plurality of predetermined objects, an evaluation unit configured to evaluate association about time and position information between the target object and an object other than the target object among the plurality of predetermined objects, a determination unit configured to determine a display manner of the plurality of predetermined objects based on the association, and a display unit configured to generate and display an image of the plurality of predetermined objects in the display manner.

### BACKGROUND OF THE INVENTION

### Field of the Invention

The present invention relates to a video processing apparatus for displaying a plurality of video images in a superimposed manner, and a method thereof.

### Description of the Related Art

Among expression techniques of sport video images are a stroboscopic video image and a comparative playback video image. Such video images are composite video images formed by superimposing at least part of a plurality of video images. For example, a stroboscopic video image expresses a series of motions of a player to be a target object on a single screen by extracting and superimposing video images of the player from a video image at constant time intervals. The stroboscopic video image displays a series of play actions made by the player like afterimages in the video image. An observer can thus understand the motions and state of the player more easily.

For example, “Dartfish User Guide”, 2011, the Internet <URL: http://www.gosportstech.com/dartfish-manuals/Dartfish%20v6.0%20User%/20Manual.pdf> discusses a method called StroMotion that extracts images expressing a series of actions of a player from a moving image and displays a stroboscopic video image in which the images are superimposed like afterimages. The foregoing literature also discusses a technique called SimulCam. SimulCam, also referred to as a comparative playback video image, is a display technique for facilitating comparison by superimposing a video image of another player or a video image of the same player captured at a different time on the same scene. European Patent No. 1287518 discusses a method for automating processing in generating a StroMotion of a sport scene.

There are composite video techniques for superimposing additional information on a video image. Examples of the additional information include superimposing and displaying not only part of a video image but also a trajectory of a player on a video image, and displaying an icon for a play. Such techniques determine color and transparency of the information to be superimposed, an icon to be displayed, and/or a time constant for specifying the period of information display based on information extracted from the scene of the video image, and visualize the content of the scene in an easily understandable manner.

A conventional stroboscopic video image can be automatically generated from a scene in which a single player appears. However, no consideration has been given to a situation where there is simultaneously a plurality of players like a team sport such as soccer. For example, if team play is visualized by using the technique discussed in European Patent No. 1287518, all the players or one selected player is displayed, and a user-desired image is not always obtained. In particular, if all the players are displayed, the image becomes complicated. If a stroboscopic video image of only a specific player in an important scene is generated, the contribution of another player contributing to the scene is not visualized. Such a stroboscopic video image is not helpful in understanding the scene.

### SUMMARY OF THE INVENTION

The present invention is directed to a video processing apparatus capable of displaying a plurality of target objects according to their associations.

According to an aspect of the present invention, a video processing apparatus includes an acquisition unit configured to acquire a video image, an object extraction unit configured to extract a plurality of predetermined objects from the video image, a selection unit configured to select a target object to be an observation target from the plurality of predetermined objects, an evaluation unit configured to evaluate association about time and position information between the target object and an object other than the target object among the plurality of predetermined objects, a determination unit configured to determine a display manner of the plurality of predetermined objects based on the association, and a display unit configured to generate and display an image of the plurality of predetermined objects in the display manner.

Further features of the present invention will become apparent from the following description of exemplary embodiments with reference to the attached drawings.

### BRIEF DESCRIPTION OF THE DRAWINGS

FIG. 1 is a schematic diagram illustrating an imaging scene of a futsal game.

FIG. 2 is a block diagram illustrating a functional configuration of a video processing apparatus.

FIG. 3 is a schematic diagram illustrating a method for extracting target areas.

FIG. 4 is a schematic diagram illustrating a method for selecting an evaluation target and evaluated targets.

FIG. 5 is a diagram illustrating a motion direction feature amount.

FIG. 6 is a flowchart illustrating processing for evaluating an association degree.

FIG. 7 is a flowchart illustrating processing by the video processing apparatus.

FIG. 8 is a block diagram illustrating a functional configuration of a video processing apparatus according to a second exemplary embodiment.

FIG. 9 is a block diagram illustrating a third exemplary embodiment.

### DESCRIPTION OF THE EMBODIMENTS

Exemplary embodiments will be described in detail below with reference to the drawings.

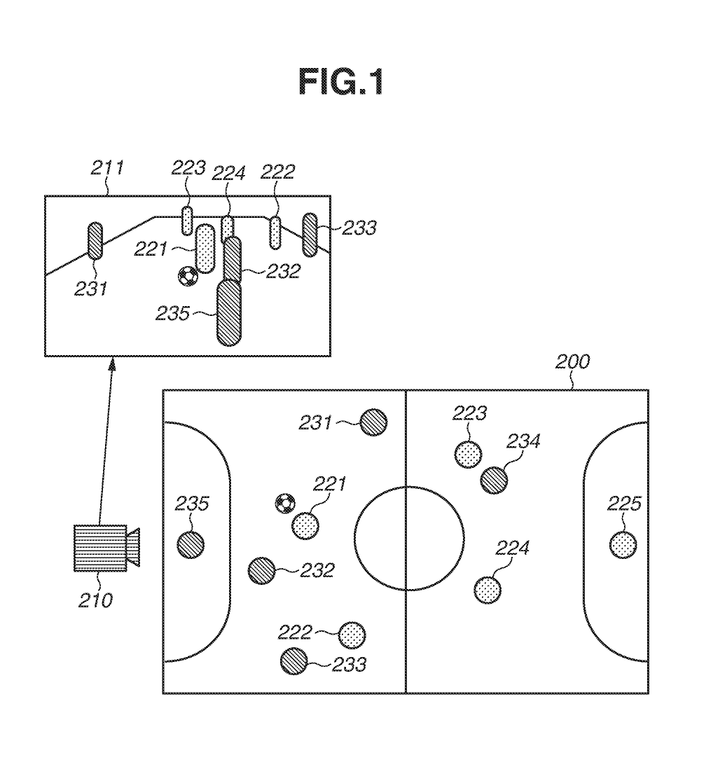

A first exemplary embodiment will be described with a video image of a futsal game as a target video image, and players in the video image as target objects. FIG. 1 is a schematic diagram illustrating an imaging scene of a futsal game. For the imaging, a camera 210 is installed at a position capable of imaging a field 200. The camera 210 outputs a video image at time t as a camera video image 211. There are ten players in the field 200. Here, players 221 to 225 in team A and players 231 to 235 in team B are playing a futsal game in the field 200. Ellipses in the camera video image 211 represent persons (players 221 to 225 in team A and players 231 to 235 in team B). At time t, the player 221 keeps the ball. The player 221 makes a pass action up to time (t+k).

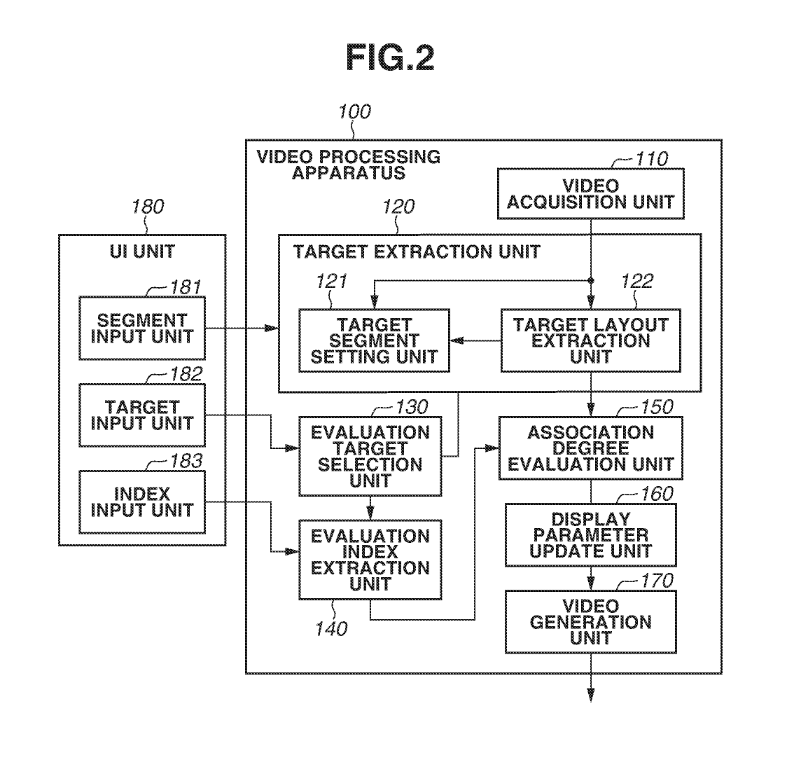

FIG. 2 is a block diagram illustrating a functional configuration of a video processing apparatus according to the first exemplary embodiment. A video processing apparatus 100 is an information processing apparatus including an input device, and includes a central processing unit (CPU), a read-only memory (ROM), and a random access memory (RAM). The CPU executes a computer program stored in the ROM by using the RAM as a work area, whereby the information processing apparatus functions as the video processing apparatus 100 according to the present exemplary embodiment. The input device includes a keyboard and a pointing device such as a mouse and a touch panel. The input device functions as a user interface (UI) unit 180.

The UI unit 180 includes at least one of a segment input unit 181, a target input unit 182, and an index input unit 183. The UI unit 180 inputs information into the video processing apparatus 100.

The video processing apparatus 100 is connected to the camera 210, and sequentially obtains the camera video image 211 from the camera 210. The video processing apparatus 100 includes a video acquisition unit 110, a target extraction unit 120, an evaluation target selection unit 130, an evaluation index extraction unit 140, an association degree evaluation unit 150, a display parameter update unit 160, and a video generation unit 170. Such units may be implemented by executing a computer program by the CPU. However, at least some of the units may be configured by hardware.

The video acquisition unit 110 acquires the camera video image 211 from the camera 210 installed in the field 200. In the present exemplary embodiment, the camera 210 is described to be installed in a fixed manner. However, the camera 210 is not limited thereto and a handheld camera or a camera system capable of panning, tilting, and zooming, and/or dolly imaging may be used. The camera video image 211 may be a plurality of video images captured by a plurality of installed cameras 210, not just one camera 210. The camera video image 211 may include video images captured in different games played at different times. In other words, the video acquisition unit 110 is not limited to the camera 210 and may be capable of acquiring video images from external devices that can output video images.

The target extraction unit 120 includes a target segment setting unit 121 and a target layout extraction unit 122. The target segment setting unit 121 sets a segment region of target objects in a time direction based on the camera video image 211. The target layout extraction unit 122 extracts areas or layout of the target objects from a video image of the segment region or at a single time. As described above, in the present exemplary embodiment, the target video image is the video image of a futsal game. The players in the video image are set as target objects. The target extraction unit 120 extracts a temporal and spatial segment region in which the target objects exist, based on frames in which the target objects exist and the positions and sizes of the target objects in the frames.

For example, the target segment setting unit 121 sets a segment region in the time direction according to a user's direct instructions from the segment input unit 181 or automatically. Examples of a method for automatically setting a segment region in the time direction include one for setting a temporal start point and end point of the video image to be extracted by using a technique for detecting a change point in a video image through a Kalman filter or from a probability density ratio. Details of the technique for detecting a change point in a video image through a Kalman filter or from a probability density ratio are discussed, for example, in Ide, “Anomaly Detection and Change Detection”, Kodansha, 2015. Any other technique may be used as long as an appropriate segment region for performing video generation can be set. Examples thereof include a method for performing recognition processing of events such as a “pass” and setting a video segment in which a target event occurs as the segment region in the time direction. The target segment setting unit 121 according to the present exemplary embodiment sets (k+1) frames of partial video images at from time t to time (t+k) as a target segment.

The target layout extraction unit 122 obtains spatial position information about the target objects in the camera video image 211. For example, the target layout extraction unit 122 detects person areas at each time from the camera video image 211, and expresses areas of high person likelihood as target layout information by rectangular areas. Details of the method is discussed in P. Felzenszwalb, D. Mcallester, and D. Ramanan, “A Discriminatively Trained, Multiscale, Deformable Part Model”, in IEEE Conference on Computer Vision and Pattern Recognition, 2008. The target layout extraction unit 122 may calculate trajectories of target objects, such as a player and a ball, in the camera video image 211 as target layout information by using a tracking technique such as a head area tracking and a particle filter.

The target layout extraction unit 122 may obtain a layout relationship between the target objects on the field 200 not only by using the camera video image 211 but also by using sensors directly attached to the players and the ball. Sensors such as a Global Positioning System (GPS) sensor, a radio frequency identifier (RFID) tag, and an iBeacon® can be used. The target objects are not limited to persons such as a player, and may include non-person objects such as a ball in the case of a ball game like succor and futsal.

In the present exemplary embodiment, the target objects are determined by an automatic detection using a detector, or by a manual direct designation. However, this is not restrictive. The present exemplary embodiment can be applied even in a case where what the target objects are like is unknown. For example, in the present exemplary embodiment, if the camera 210 is fixed, a method for separating the foreground and the background by using a background subtraction technique so that target areas are extracted at each time and target objects are not explicitly defined as specific persons may be used. The spatial position information about the target objects may indicate positions not within the camera video image 211. For example, the target layout extraction unit 122 may extract the spatial position information about the target objects as three-dimensional spatial positions on the field 200 by using a plurality of cameras 210 and/or a device capable of acquiring information relating to a distance and a direction, like a range finder, as well.

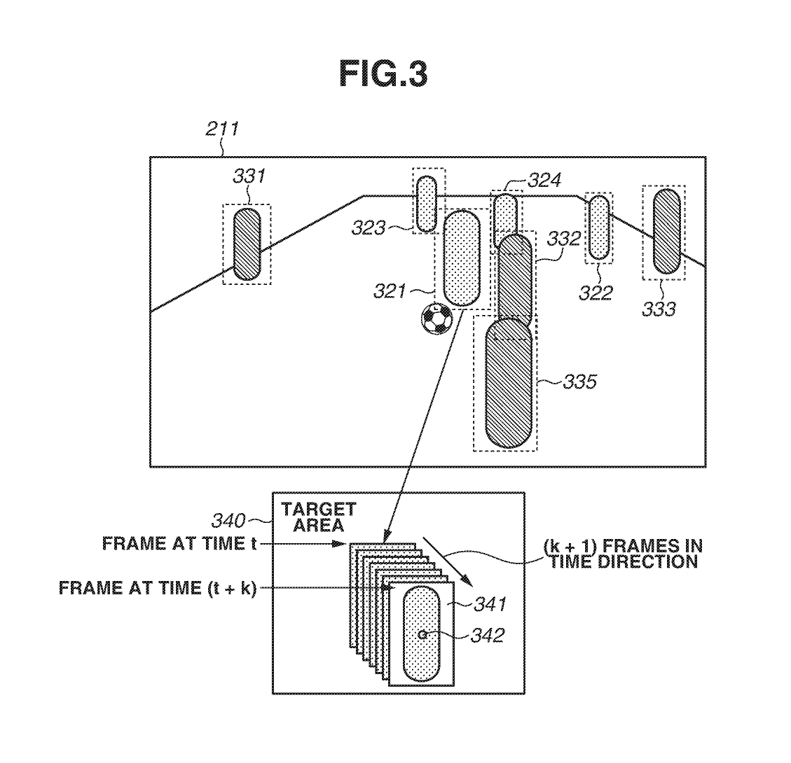

FIG. 3 is a diagram illustrating a method for extracting a target area by the target extraction unit 120. The target extraction unit 120 extracts a target area 340 from (k+1) frames of the camera video image 211 of a futsal game from at times t to (t+k). The layout of the target objects at time t is represented by target layouts 321 to 335 in dot-lined frames. The target layout extraction unit 122 of the target extraction unit 120 extracts the player 221 of the target layout 321 by rectangular frame detection of a person detector. The extraction of the target layout is performed with respect to each player in the camera video image 211. The extraction results of the target layout are expressed as the player-by-player target layouts 321 to 335.

A procedure for extracting the target area 340 of the player 221 keeping the ball by the target segment setting unit 121 and the target layout extraction unit 122 will be described.

The target layout extraction unit 122 extracts candidate areas that are likely to include a person from the camera video image 211 at time t by the foregoing method for detecting person areas from a video image. The target layout extraction unit 122 extracts a rectangular area that is likely to include the player 221 as the target layout 321 from among the candidate areas. The target area 340 is formed by connecting, in the time direction, the target layouts 321 to 341 of the player 221 in respective frames at times t to (t+k). The target layout extraction unit 122 may combine a plurality of elements. For example, the target layout extraction unit 122 may define, as a target to be extracted, a trajectory formed by connecting barycentric positions 342 of the target layouts 321 to 341 from times t to (t+k).

In the present exemplary embodiment, the target areas of the players are set in the same time segment by performing processing in order of the target segment setting unit 121 to the target layout extraction unit 122. However, this is not restrictive. For example, the target layout extraction unit 122 may perform processing first to extract spatial target areas, and the processing of the target segment setting unit 121 may be performed on the target areas to set different time segments for the respective target objects.

For example, the target layout extraction unit 122 extracts person areas in the camera video image 211 at time t. Then, the target segment setting unit 121 may make settings in the segment direction by performing tracking processing of partial areas in a video direction. An example of the tracking processing of partial areas in a video direction is discussed in Z. Kalal, J. Matas, and K. Mikolajczyk, “P-N Learning: Bootstrapping Binary Classifiers by Structural Constraints”, Conference on Computer Vision and Pattern Recognition, 2010.

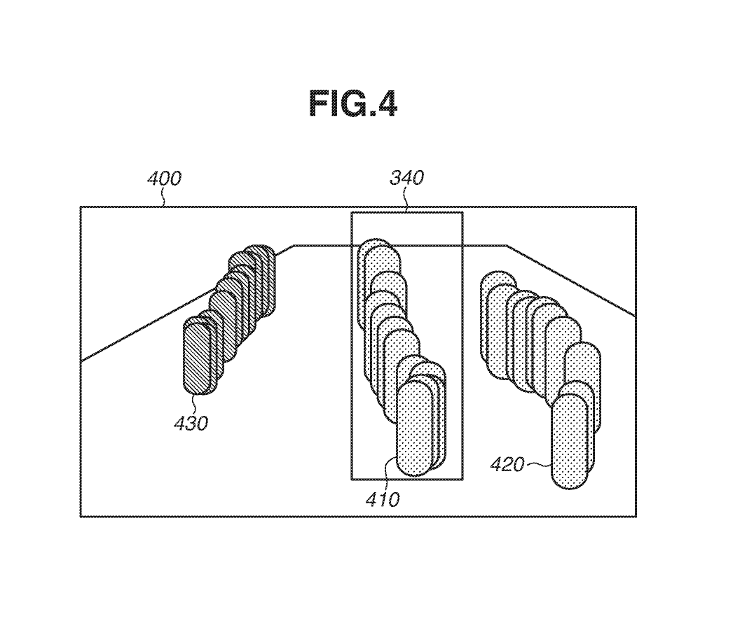

The evaluation target selection unit 130 selects objects to be an evaluation target and evaluated targets from the plurality of target objects extracted by the target extraction unit 120. FIG. 4 is a diagram illustrating processing for selecting an evaluation target and evaluated targets. FIG. 4 illustrates a composite video image 400 as a stroboscopic video image, in which the target areas of the players 221 and 222 in team A and the player 231 in team B in respective frames at times t to (t+k) are superimposed. Here, the player 221 is set as a current evaluation target 410. The main evaluation target 410 is manually selected by the user by using the target input unit 182, or automatically selected from among players nearby by tracking the position of the ball.

The evaluation target selection unit 130 may perform recognition processing on a specific action by using an action recognition technique, and based on the result, select a target object most closely associated with the specific action among candidate targets as the evaluation target 410. In such a case, the evaluation target selection unit 130 selects target objects closely associated with the action of the evaluation target 410 as evaluated targets 420 and 430. An example of the action recognition technique is discussed in Simonyan, K., and Zisserman, A.: Two-stream convolutional networks for action recognition in videos. In Proc. NIPS, 2014.

The evaluation target 410 and the evaluated targets 420 and 430 do not need to be players, and may be changed to a ball, a racket, and the like according to the nature of the game or match to be visualized and information to be obtained. In addition, the evaluation target 410 does not need to be a single target area 340. A plurality of target areas may be selected if the action is associated with a plurality of players like a pass play.

The evaluation target selection unit 130 also performs comparison by setting the player 222 in team A as the evaluated target 420 and the player 231 in the opposing team B as the evaluated target 430. While only the players 222 and 231 are selected here as evaluated targets for evaluation, this is just an example. All the players may be set as an evaluated target in turns and subjected to the evaluation with the evaluation target 410.

The evaluation target selection unit 130 may exclude objects outside a predetermined area in the camera video image 211, such as spectators outside the field 200, from being set as a target object. For example, such objects can be excluded from the selection of target objects by processing for excluding person areas outside the field 200 by using position information or rectangular sizes in advance, or attaching GPS sensors to the players and handling only person areas inside the field 200. The referee in the field 200 may also be excluded from the target objects by individually making a determination, using a GPS or RFID sensor or color features in the video image.

The evaluation index extraction unit 140 extracts an evaluation index for evaluating an association degree between the evaluation target 410 and the evaluated target 420 selected by the evaluation target selection unit 130. The “association degree” is obtained by evaluating association about times and areas based on motion information and appearance information between the evaluation target 410 and the evaluated target 420. For example, the “motion information” refers to motion information about a partial area in a target area. Examples of the motion information about a partial area include a pixel-by-pixel motion vector such as an optical flow, a histogram of optical flow (HOF) feature amount, and a dense trajectories feature amount. The dense trajectories feature amount is discussed in H. Wang, A. Klaser, C. Schmid, C. L. Liu, “Dense trajectories and motion boundary descriptors for action recognition”, Int J Comput Vis, 103 (1) (2013), pp. 60-79. The motion information may be a result of tracking a point or an area across a target segment. Examples thereof include a particle filter and a scale-invariant feature transform (SIFT) tracker.

Any information that indicates how part or all of a target area moves in the video image may be used as the motion information. For example, the motion information is not limited to the camera video image 211, and may be information about the motion of the target object, obtained from a GPS or acceleration sensor attached to the player.

In a case of a video feature, the “appearance information” may include, for example, a red, blue, and green (RGB) or other color feature, and information expressing the shape, pattern, and/or color of the target object like histogram of oriented gradients (HOG) information indicating information about a shape such as an edge and a SIFT feature. The appearance information is not limited to a video image and may be information expressing the material of the target object, such as the texture of surface material, or the shape of the target object like optical reflection information. Examples thereof include depth information from an imaging apparatus such as Kinect®, and a bidirectional reflectance distribution function (BRDF). The BRDF is discussed in N. Nicodemus, J. Richmond, and J. Hsia, “Geometrical considerations and nomenclature for reflectance”, tech. rep., U.S. Department of Commerce, National Bureau of Standards, October 1977.

Other than the above-described information, the evaluation index extraction unit 140 may extract likelihood during recognition processing for the action recognition or person detection, such as that used in the processing in a previous stage by the target extraction unit 120, the target segment setting unit 121, or the target layout extraction unit 122, as an evaluation index of the association degree. Alternatively, the evaluation index extraction unit 140 may extract, as the evaluation index, information or a feature amount of an intermediate product of a hierarchical recognition method such as deep learning. The evaluation index extraction unit 140 may perform additional feature amount extraction processing to evaluate the association degree. The evaluation index extraction unit 140 may extract information associated with the target object, such as information obtained from a heart rate sensor attached to the target object, as the evaluation index.

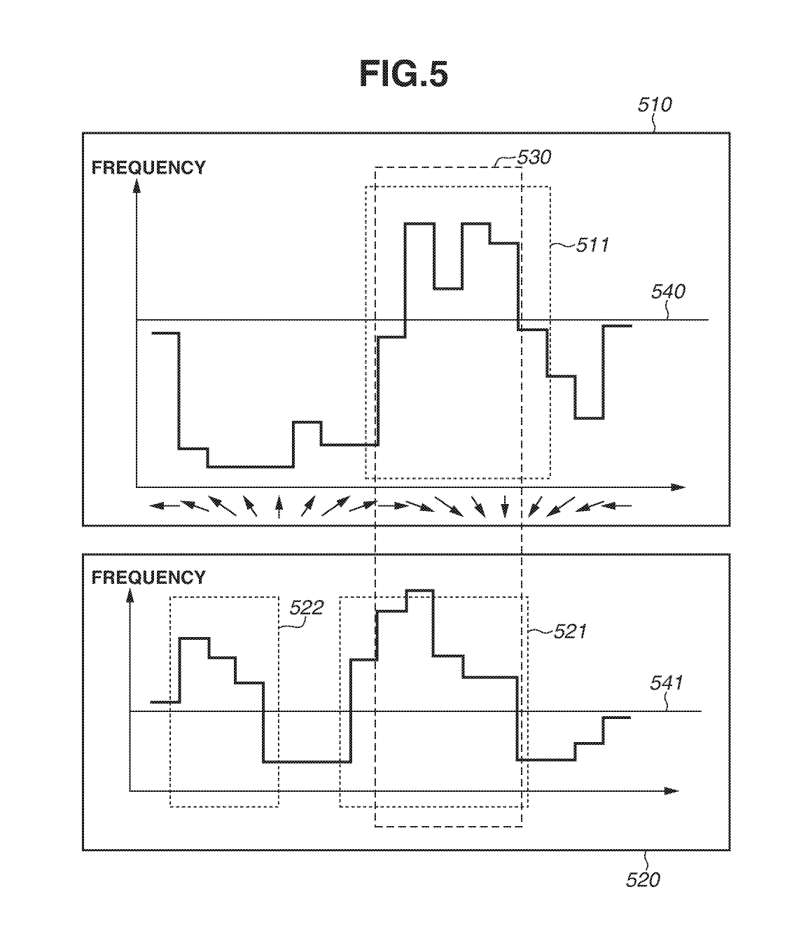

In the present exemplary embodiment, the evaluation index extraction unit 140 uses, as the evaluation index, a motion direction feature amount obtained by calculating a motion direction of the target object in the target area frame by frame, and tallying the motion directions for each bin of respective 16 directions. FIG. 5 is a diagram illustrating a motion direction feature amount. FIG. 5 is a histogram in which the horizontal axis indicates the motion direction and the vertical axis the occurrence frequency of the motion direction (motion direction frequency) in the target area over the entire time and space. Motion direction frequencies are values obtained by integrating all the bins of the motion directions in the target area in the respective motion directions. The motion direction frequencies indicate, in terms of frequency, what motion occurs how often in the target area. A method for selecting an evaluation index for evaluating the association degree of motions between an evaluation target and an evaluated target from among the motion directions will be described.

FIG. 5 illustrates a motion direction frequency distribution 510 of the evaluation target 410 and a motion direction frequency distribution 520 of the evaluated target 420 at times t to (t+k). The motion direction frequency distribution 510 of the evaluation target 410 includes a high frequency region 511 in which the motion direction frequency is higher than or equal to a predetermined setting threshold 540. The motion direction frequency distribution 520 of the evaluated target 420 includes high frequency regions 521 and 522 in which the motion direction frequency is higher than or equal to a predetermined setting threshold 541. The high frequency region 511 and the high frequency region 521 include a common region 530 between the evaluation target 410 and the evaluated target 420. The motion directions included in the common region 530 are set as an evaluation index. A region in which the evaluated target 420 moves in the same direction in a manner corresponding to the evaluation target 410 which makes a kick is thereby visualized. As for the evaluated target 430 that is performing defense against the evaluation target 410, a state of moving in the same direction is visualized.

In the present exemplary embodiment, the same direction is detected by using the common region 530. However, the method for extracting regions having a high association degree is not limited thereto. For example, fanning-out motions may be extracted to have a high association degree by offsetting directions (e.g., to 180° opposite directions). While previously-set moving directions have been described as an example of the feature amount of the evaluation target 410 according to the present exemplary embodiment, a RGB feature, HOG feature, or SIFT feature may be used as the appearance information other than the above-described feature amount. The feature amount is not limited to a video feature, either. Feature amounts other than a video feature, such as GPS-based position information, may be used.

A feature vector collectively including a plurality of pieces of motion information, appearance information, and/or feature amounts of an intermediate product may be used. In such a case, only principal feature amounts are extracted by using a component analysis technique such as principal component analysis (PCA) and independent component analysis (ICA), a dimension reduction technique, clustering, or a feature selection technique on the feature vector. Closely associated feature amounts can thereby be automatically extracted from data without artificial judgment. The user may directly specify feature amounts by using the index input unit 183.

In the present exemplary embodiment, a single region is designated as the common region 530. However, a plurality of regions may be designated. In such a case, a plurality of evaluation indexes can be visualized by setting different identifiers (IDs) and parallelizing the subsequent processing.

The association degree evaluation unit 150 evaluates the association degree between the evaluation target 410 and the evaluated target 420 or 430 by using the common region 530 extracted by the evaluation index extraction unit 140. In the present exemplary embodiment, transparency of the target area of the evaluated target 420 with respect to the target area 340 of the evaluation target 410 is changed frame by frame according to the magnitude of the association degree. For that purpose, the association degree evaluation unit 150 calculates the association degree with the evaluation index of the evaluation target 410 frame by frame by evaluating the association degree with the evaluation index in the target region of the evaluated target 420 frame by frame.

The display parameter update unit 160 determines a display parameter frame by frame in superimposing the target area of the evaluated target 420 on the input camera video image 211 according to the reciprocal of the association degree. In the present exemplary embodiment, the display parameter update unit 160 determines transparency as the display parameter.

The video generation unit 170 generates a composite video image according to the association degree between the evaluation target 410 and the evaluated target 420 in each frame. The video generation unit 170 generates the composite video image so that the evaluated target 420 is displayed according to the display parameter.

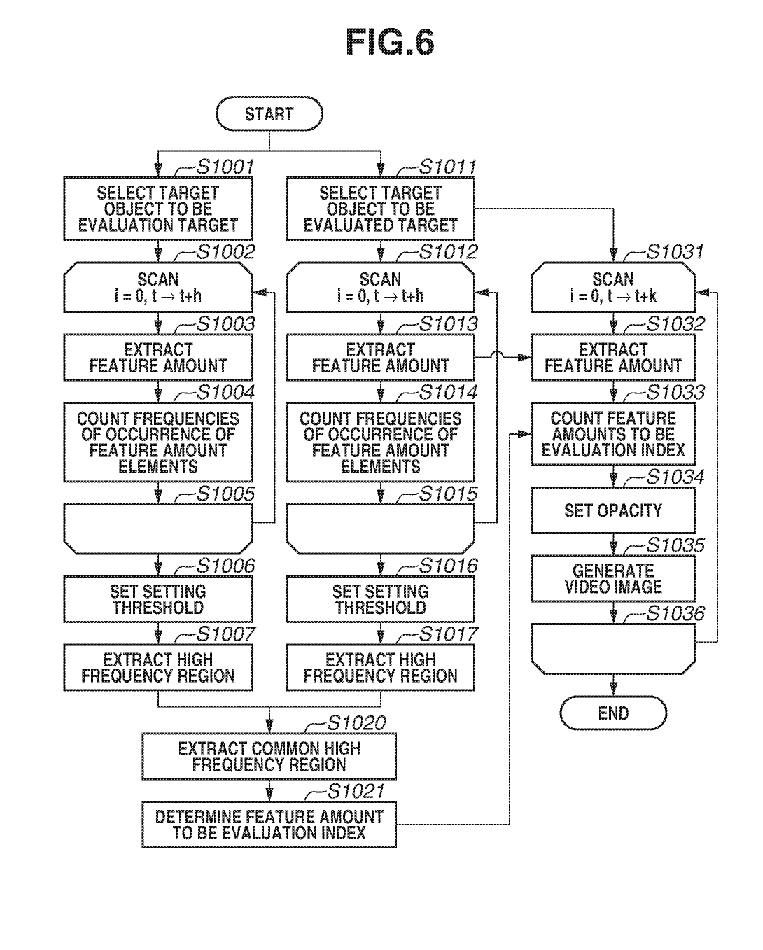

FIG. 6 is a flowchart illustrating processing for evaluating the association degree. FIG. 6 illustrates processing by the evaluation target selection unit 130, the evaluation index extraction unit 140, the association degree evaluation unit 150, and the display parameter update unit 160.

In step S1001, the evaluation target selection unit 130 selects a target object to be an evaluation target 410 from a plurality of target objects extracted by the target extraction unit 120, and inputs a target area 340 according to the evaluation target 410 into the evaluation index extraction unit 140. In steps S1002 to S1005, the evaluation index extraction unit 140 scans each frame for the input target area 340, and extracts the target area 340 in each frame. In step S1003, the evaluation index extraction unit 140 extracts a feature amount from the target area 340 in each frame. In the present exemplary embodiment, the evaluation index extraction unit 140 extracts the feature amount by calculating and allocating an optical flow into bins of 16 directions. In step S1004, the evaluation index extraction unit 140 counts the occurrence frequencies of the respective extracted feature amount elements, and reflects the distribution of the occurrence frequencies of the feature amount elements in all the frames, on a feature frequency histogram exemplified by the motion direction frequency distribution 510 of the evaluation target 410. In step S1006, the evaluation index extraction unit 140 sets a setting threshold 540 for the occurrence frequency, and extracts a histogram region in which the occurrence frequency is higher than or equal to the setting threshold 540. In step S1007, the evaluation index extraction unit 140 extracts a high frequency region 511 on the histogram of the evaluation target 410 based on the extracted histogram region in which the occurrence frequency is higher than or equal to the setting threshold 540.

In steps S1011 to S1017, the evaluation target selection unit 130 and the evaluation index extraction unit 140 perform processing similar to that of steps S1001 to S1007 on the evaluated target 420. In the histogram generated here (motion direction frequency distribution 520 of the evaluated target 420), the same feature amount as that of the histogram (motion direction frequency distribution 510) of the evaluation target 410 is used.

In step S1020, the evaluation index extraction unit 140 compares the high frequency region 511 of the evaluation target 410 with high frequency regions 521 and 522 of the evaluated target 420 to extract a high frequency region common therebetween (common region 530). In step S1021, the evaluation index extraction unit 140 determines a feature amount to be an evaluation index from the extracted high frequency region.

In steps S1031 to S1036, the evaluation index extraction unit 140 and the association degree evaluation unit 150 scan each frame for the evaluated target 420 again, sets a display parameter of the target area frame by frame, and performs composition. In step S1032, the evaluation index extraction unit 140 extracts the feature amount of the target area in a predetermined frame. Since this process is the same as that of step S1013, the two processes may be made common.

In step S1033, the association degree evaluation unit 150 counts how much the feature amount determined to be the evaluation index in step S1021 is included in the target area of the current frame. In step S1034, the display parameter update unit 160 sets opacity according to the frequency of the feature amount to be the evaluation index, counted by the association degree evaluation unit 150. The display parameter update unit 160 calculates the ratio of the frequency of the feature amount to be the evaluation index in the current frame with respect to the total occurrence frequency of the feature amount to be the evaluation index in all the frames, and simply expresses the ratio as the opacity of the target object. In step S1035, the video generation unit 170 generates a video image by combining the target area of the evaluated target 420 in each frame with the camera video image 211 based on the opacity (display parameter) set by the display parameter update unit 160. The higher the occurrence frequency of the evaluation index in the current frame, the more opaque the target area. As a result, the target areas of frames containing more evaluation index components remain in the camera video image 211.

The processing of the video generation unit 170 will be described in detail. For example, the video generation unit 170 separates the foreground from the background of the camera video image 211 by performing background subtraction frame by frame, and performs target extraction processing only on the foreground. The video generation unit 170 can thereby extract an area video image of the evaluated target 420 with the background excluded from the rectangular area. The video generation unit 170 applies the opacity set by the display parameter update unit 160 with respect to the extraction result of each frame, and adds the resultant to the camera video image 211. The higher the association degree with the evaluation target 410, the more opaque the superimposed result of the evaluated target 420. This can generate a composite video image in which a coordinated play can be easily identified. Moreover, the video generation unit 170 can prevent the video images from lasting for a long time by setting a time constant and increasing the transparency over time. The video generation unit 170 can also control the lasting time by linking the time constant itself with the association degree.

Display parameters that the display parameter update unit 160 can update, in addition to the transparency, include RGB ratios, as well as RGB values and line type of additional information in superimposing additional information such as a trajectory and a person rectangle, and display elements such as an icon. If the evaluation index varies from one evaluated target to another or if there is a plurality of evaluation indexes, the display parameter update unit 160 updates such display parameters, whereby the video generation unit 170 can visualize a plurality of association degree elements. Only a desired evaluation index can be specified by changing the evaluation index to be visualized via the index input unit 183.

The video processing apparatus 100 can visualize only the target object to be observed and a target object or objects moving in association therewith according to the association degree and assist the user in understanding a series of coordinated plays by performing the above-described processing on each evaluation target. This can solve the conventional problem that all video images are superimposed and thereby too much information is superimposed to recognize what coordinated plays have been made.

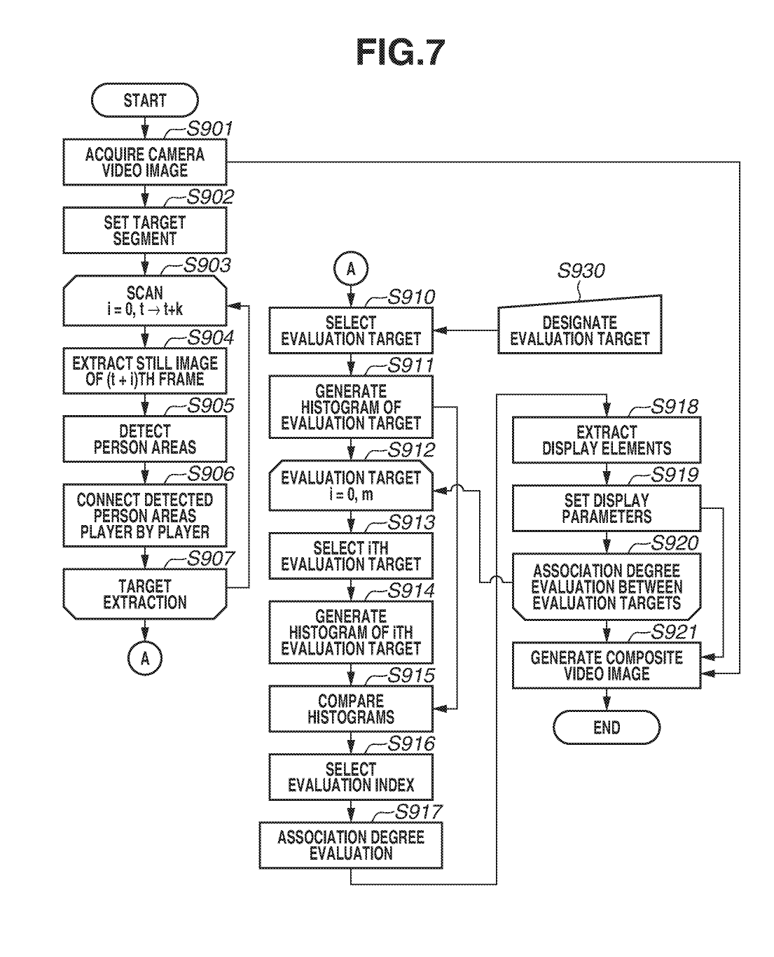

FIG. 7 is a flowchart illustrating processing by the video processing apparatus 100.

In step S901, the video acquisition unit 110 acquires the camera video image 211 from the camera 210 installed in the field 200. In step S902, the target extraction unit 120 sets a target segment for the frames of the camera video image 211 at times t to (t+k) by using the target segment setting unit 121.

In steps S903 to S907, the target layout extraction unit 122 of the target extraction unit 120 extracts an evaluation target 410 by scanning the set target segment for k frames and accumulating target areas in the respective frames. In step S904, the target layout extraction unit 122 extracts a still image of the (t+i)th frame from the camera video image 211 of the target segment. In step S905, the target layout extraction unit 122 detects person areas from the extracted still image. In step S906, the target layout extraction unit 122 connects the person areas detected from the frames player by player to generate evaluation target areas. The present exemplary embodiment deals with a case where m players are detected.

In step S930, the user directly designates the evaluation target 410 by using the target input unit 182. In step S910, the evaluation target selection unit 130 selects the evaluation target 410 from the m players according to the direct designation. The target input unit 182 accepts the designation of the evaluation target 410, for example, through direction designation on-screen by a pointing device, and transmits the content of the designation to the evaluation target selection unit 130. The evaluation target selection unit 130 registers the designated player as the evaluation target 410. This enables emphasizing display of a player or players having a high association degree with the main evaluation target 410 among the m players in the camera video image 211, and de-emphasizing display of players having a low association degree.

In step S911, the evaluation index extraction unit 140 extracts a feature amount, such as an image feature and a motion feature, of the player of the evaluation target 410. The evaluation index extraction unit 140 detects an optical flow from each target area, counts the occurrence frequencies of the optical flow quantized in 16 directions, and generates a histogram of the occurrence frequency (motion direction frequency distribution 510). Other examples of the feature amount usable by the evaluation index extraction unit 140 include a trajectory of the barycentric positions of the target areas, absolute values of differential values thereof (to avoid dependence on turning directions), and an L¹ norm of speed.

In steps S912 to S920, the association degree evaluation unit 150 evaluates the association degrees of evaluation targets (players) other than the player of the main evaluation target 410 in the camera video image 211 by iterations, using different evaluation indexes for the respective evaluation targets. The processing of step S910 and the subsequent steps is similar to the processing of FIG. 6.

In step S913, the evaluation index extraction unit 140 selects, for example, the player of the evaluated target 420 as an evaluation target of i=0. In step S914, the evaluation index extraction unit 140 calculates the histogram (motion direction frequency distribution 520) of the player of the evaluated target 420. In step S915, the evaluation index extraction unit 140 compares the histogram (motion direction frequency distribution 510) of the player of the evaluation target 410 with the histogram (motion direction frequency distribution 520) of the player of the evaluated target 420. In step S916, the evaluation index extraction unit 140 selects an evaluation index having a high association degree with the two evaluation targets, based on the comparison. The evaluation index extraction unit 140 performs AND operation of the two histograms of the occurrence frequency (motion direction frequency distributions 510 and 520), and selects a common region 530 where the occurrence frequencies are similarly high. Depending on the content of a play, the association degree can be high even between different directions, like when the players fan out or when the players cross in opposite directions. In such a case, the evaluation index extraction unit 140 may use not an association degree based on high similarity but an association degree obtained by offsetting. The feature amount included in the common region 530 represents a feature that occurs in common from the player of the evaluation target 410 and the player of the evaluated target 420 in the target segment, and can thus be regarded to have a high association degree.

Similarly, suppose, for example, that an evaluation target of i=1 is the player of the evaluated target 430. In such a case, the histogram of the optical flow includes more leftward components (high frequency region 522). The AND of the histograms (motion direction frequency distributions 510 and 520) therefore includes hardly any high frequency region. The player of the evaluated target 430, when visualized, is therefore not emphasized. The evaluation target 410 and the evaluated target 430 belong to different teams, and are thus expected to wear uniforms of significantly different RGB profiles. Therefore, the association degree can be made even lower by extracting not only the optical flow from the evaluation target 410 but the RGB values of each pixel in the still image areas as well, and generating histograms thereof.

In step S917, the evaluation index extraction unit 140 scans the evaluation target of i=0, i.e., the evaluated target 420 at times t to (t+k) for association degree evaluation, and generates a histogram (motion direction frequency distribution 520) frame by frame. The evaluation index extraction unit 140 calculates a feature amount content ratio of the common region 530 in the generated histogram of each frame, and sets the calculated result as the association degree of the frame. The association degree evaluation unit 150 evaluates this association degree.

In step S918, the display parameter update unit 160 extracts display elements in generating a composite video image. For example, in a case of the player of the evaluation target 410, partial images of the evaluation target areas (i.e., rectangular areas of the player) are extracted as display elements to generate a stroboscopic video image. In a case of the player of the evaluated target 420, a series of barycentric positions of the evaluation target areas in the respective frames are extracted as display elements. In such a manner, the display elements to be extracted may vary from one evaluation target to another.

In step S919, the display parameter update unit 160 sets a display parameter frame by frame about how the display elements are superimposed. Examples of the display parameter for the display elements of the player of the evaluation target 410 include flash intervals for generating a stroboscopic video image, and transparency during superimposition. Examples of the display parameter for the display elements of the player of the evaluated target 420 include the RGB values of a trajectory, transparency, and a time constant for disappearance of display.

The processing of steps S912 to S920 is performed on each evaluation target, whereby the display parameter of each evaluation target in each target segment is set. In step S921, the video generation unit 170 generates and displays a composite video image based on the display parameters.

By the processing described above, the players of evaluation targets other than the player of the designated evaluation target 410 can be displayed according to the association degrees with the player of the evaluation target 410. Therefore, a video image that facilitates intuitive understanding of how the players are associated with each other in constructing the target scene can be provided.

In a second exemplary embodiment, a composite video image is generated based on an evaluation of a camera video image different from that of a predetermined game. Examples of such a different camera video image include that of a game played at a different time or date and that of a game of different teams. In the present exemplary embodiment, an association degree between a plurality of evaluation targets in a moving image captured in a different time period or on a different date is evaluated with respect to a camera video image captured in a current time period. Information about an evaluation target having a high association degree and of a different time is thereby displayed on the camera video image of the current time. As a result, a similar play, such as a coordinated play and a set play in another game or during training, can be displayed in a superimposed manner and utilized for game analysis. In the present exemplary embodiment, unlike the first exemplary embodiment, no specific evaluation target is set. A time segment of a scene is set instead, and a composite video image is generated according to the association degrees of respective evaluated targets with the entire scene.

In the first exemplary embodiment, the evaluation target 410 and the evaluated targets 420 and 430 are set by the user directly designating an evaluation target in the scene by using the target input unit 182. In the present exemplary embodiment, no evaluation target is directly designated, but a time region is directly designated for the target segment setting unit 121 by using the segment input unit 181.

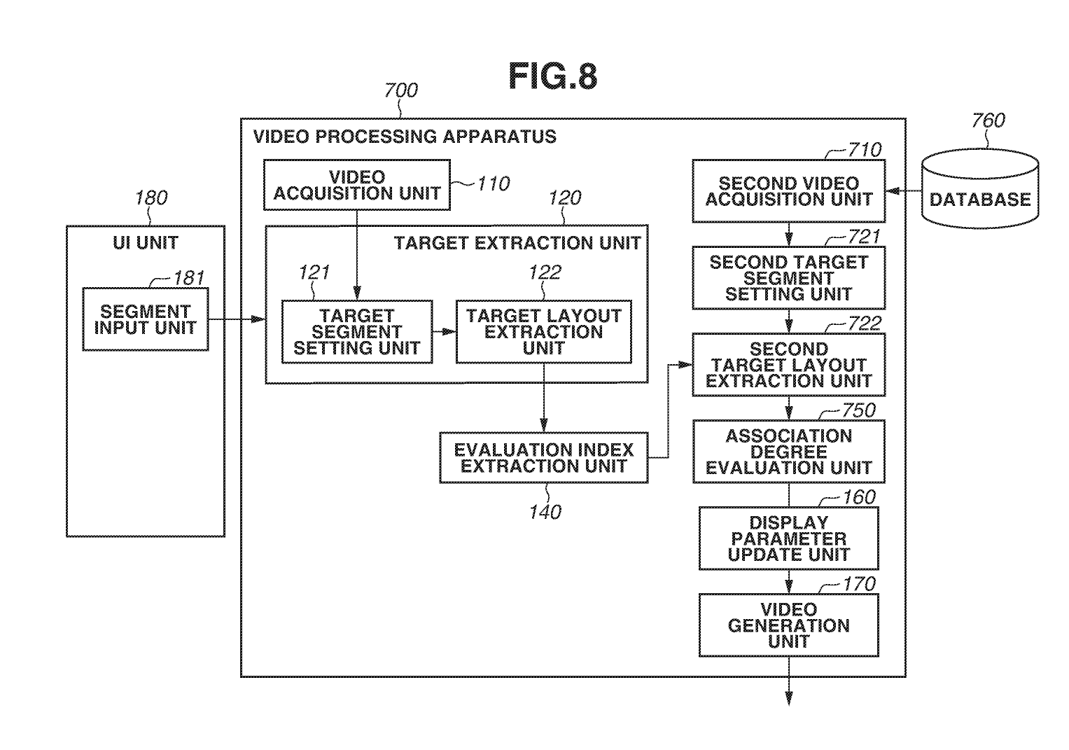

FIG. 8 is a block diagram illustrating a functional configuration of a video processing apparatus 700 according to the second exemplary embodiment. Components common with the video processing apparatus 100 of the first exemplary embodiment illustrated in FIG. 2 are denoted by the same reference numerals. A description of the common components will be omitted.

The video acquisition unit 110 acquires a camera video image (first input image) of a game currently being played, captured by a camera 210, like the video acquisition unit 110 of the first exemplary embodiment. Other than the camera video image of the game at the current time, the video acquisition unit 110 may acquire a video image of a user-desired scene from a database 760. The video acquisition unit 110 may acquire a video image of a game of other teams from another database or terminal.

A second video acquisition unit 710 extracts and acquires a video image of a past game (second input image) as needed from video images of previous games stored in the database 760.

The segment input unit 181 of the UI unit 180 accepts designation of a video sequence that the user wants to focus on, through user operations. The segment input unit 181 inputs the content of the accepted designation into the video processing unit 700. In the present exemplary embodiment, the segment input unit 181 accepts designation of an action tag such as “pass”, instead of direct input of a start time and an end time as a segment time of the video image.

The target segment setting unit 121 sets a target segment by performing action recognition processing on the first input image acquired by the video acquisition unit 110, and extracting a video sequence corresponding to a pass play. The action recognition processing is discussed in Simonyan, K., and Zisserman, A.: Two-stream convolutional networks for action recognition in videos. In Proc. NIPS, 2014. The segment time may be directly set by the user. The segment time may be set to be k frames in a specific segment of the video image.

The target layout extraction unit 122 extracts the layout of players in the video image from the target segment set by the target segment setting unit 121. The target layout extraction unit 122 according to the present exemplary embodiment uses three-dimensional position acquisition sensors such as a GPS sensor. The GPS sensors are attached to individual players to be evaluated. Thus, processing for separating the layout of target objects is not needed.

The three-dimensional positions of the players may be converted into and used in terms of coordinates on the camera 210 by using previously calculated camera parameters, if needed. If the position of the camera 210 is fixed, external parameters, such as position and angle information, and internal parameters, such as an F-number and camera distortions, can be measured in advance as camera parameters. By using such values, the target layout extraction unit 122 can convert the GPS-measured three-dimensional positions of the players on the field 200 into coordinate values on the camera video image 211.

A second target segment setting unit 721 performs action recognition processing similar to that of the target segment setting unit 121 on the second input image acquired by the second video acquisition unit 710, and extracts a target segment from the entire sequence. For example, the second target segment setting unit 721 extracts a target segment estimated to include a pass play from the entire sequence of the second input image according to the action tag “pass” set by the segment input unit 181. If a plurality of target segments is extracted, the second target segment setting unit 721 may evaluate the association degrees of all the target segments by sequential processing. The second target segment setting unit 721 may superimpose only a target segment having the highest association degree.

A second target layout extraction unit 722 extracts the layout of players according to the set target segment. If the players in the second input image wear GPS sensors as in the first input image, the second target layout extraction unit 722 can use the data from the GPS sensors. The second target layout extraction unit 722 may perform other types of target layout extraction such as the video-based target layout extraction technique described in the first exemplary embodiment.

The evaluation index extraction unit 140 performs processing for extracting evaluation indexes from the feature vectors of such evaluation targets. In the first exemplary embodiment, the evaluation index extraction unit 140 separates an evaluation target from evaluated targets, and evaluates relationships therebetween. In the present exemplary embodiment, the evaluation index extraction unit 140 extracts evaluation indexes based on a combined feature vector of a first evaluation target and a second evaluation target. The evaluation index extraction unit 140 extracts position information, speed information, and acceleration information obtained from the GPS sensors from the respective evaluation targets, integrates the information, performs a principal component analysis thereon, and extracts a feature amount occurring from both the input images in common from among the feature amounts. The evaluation index extraction unit 140 can check how many indexes are needed to evaluate the two evaluation targets, by determining a cumulative contribution ratio. The cumulative contribution ratio of up to jth vector elements in a p-dimension feature vector can be expressed by the following equation:

R={100(λ1+λ2+λ3+ . . . +λj)}/(λ1+λ2+λ3+ . . . +λp).

The higher the cumulative contribution ratio is, the more faithfully the original feature vector can be expressed. The smaller the value of “j” is, the fewer evaluation indexes are needed for expressing both the first evaluation target and the second evaluation target. The evaluation index extraction unit 140 determines a target segment by scanning a plurality of input images and target segments and evaluating the value of “j”. The evaluation index extraction unit 140 sets an eigenvector equivalent to λj's as an evaluation index.

An association degree evaluation unit 750 calculates the component content ratio of the eigenvector with respect to each evaluation target in the second target segment set by the second target segment setting unit 721, and sets the association degree according to the eigenvector of the evaluation indexes.

The video processing apparatus 700 configured as described above updates the display parameters of the evaluation targets with respect to the input video images and displays a composite video image as in the first exemplary embodiment. For association degree evaluation, the video processing apparatus 700 may use such analysis techniques as correlation analysis and multiple correlation analysis, other than the cumulative contribution ratio. Any method may be used for association degree evaluation as long as the association degrees of the evaluation targets can be calculated.

In the first and second exemplary embodiments, the extracted evaluation targets are evaluated based on a spatial relationship. In a third exemplary embodiment, association degrees are evaluated and visualized according to the story of the entire game scene by using a technique such as action recognition. Evaluating the association degrees based on the entire scene also enables application to a digest. A video processing apparatus according to the third exemplary embodiment has the same configuration as that of the video processing apparatus 100 according to the first exemplary embodiment described with reference to FIG. 2.

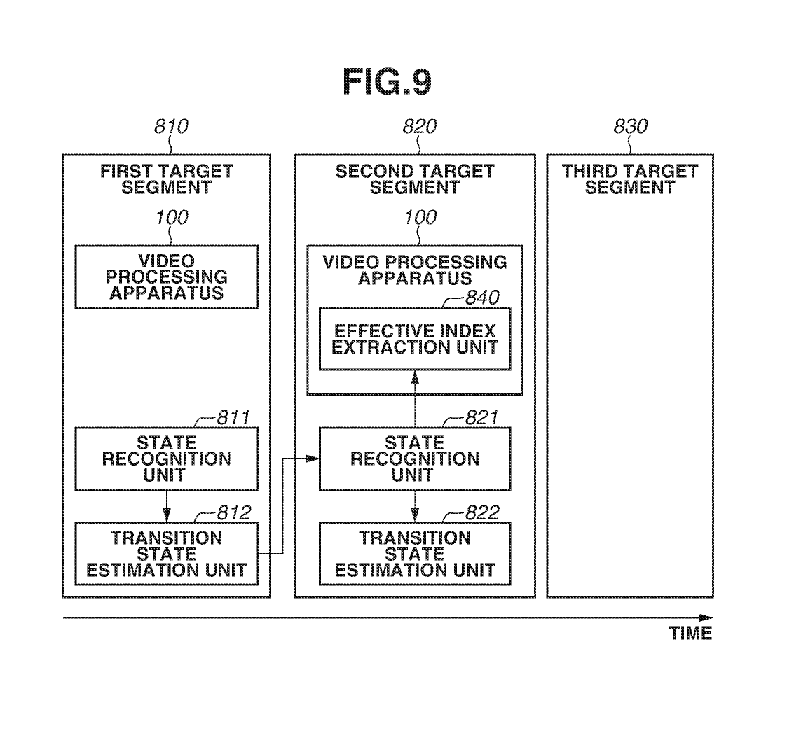

FIG. 9 is a block diagram illustrating the third exemplary embodiment. In the third exemplary embodiment, the visualization performed in the first exemplary embodiment is propagated to evaluation indexes of the next target segment, whereby influence in a time series direction is reflected on display parameters as association degrees.

The video processing apparatus 100 sets m frames within a time segment into the target segment setting unit 121 as a first target segment 810 in advance. The video processing apparatus 100 evaluates the association degrees of a plurality of evaluation targets existing in the first target segment 810 by the technique described in the first exemplary embodiment, and sets display parameters for the first target segment 810. At the same time, in the first target segment 810, a state recognition unit 811 recognizes the state of the first target segment 810 by using a tag recognition technique such as action recognition. In the present exemplary embodiment, the state of the first target segment 810 is “pass”. The state recognition unit 811 obtains, for example, optical flow-based motion feature amounts as well as image feature amounts, and performs state recognition on each target segment. The state recognition unit 811 obtains the image feature amounts, for example, by a technique discussed in Simonyan, K., and Zisserman, A.: Two-stream convolutional networks for action recognition in video images. In Proc. NIPS, 2014. The state recognition unit 811 may use the feature amounts used in the state recognition as a feature vector of the video processing apparatus 100. Processing can be simplified by using the feature extraction processing in common.

A transition state estimation unit 812 estimates the transition probabilities of next states with respect to the state recognition unit 811 by using, for example, a Bayesian network or a hidden Markov model. The Bayesian network is discussed in The Annual Meeting record I.E.E. Japan, Vol. 2011, 3, pp. 52-53, “Action Determination Algorithm of Teammates in Soccer Game”. If the state of the first target segment 810 is “pass”, the transition probability of a player entering a “trap” state in the next second target segment 820 is high. Therefore, the transition state estimation unit 812 extracts a feature distribution of the “trap” state having a high transition probability from the state recognition unit 811. The transition state estimation unit 812 extracts a feature vector effective in estimating the “trap” state as an effective index in the next second target segment 820 based on the state (here, “trap”) estimated from the previous first target segment 810 by the transition state estimation unit 812.

In the second target segment 820, a state recognition unit 821 performs a state recognition by using the effective index. At the same time, the state recognition unit 821 extracts the effective index by using an effective index extraction unit 840 instead of the evaluation index extraction unit 140. The effective index extraction unit 840 performs a principal component analysis on the “trap” state among extracted feature vectors. The effective index extraction unit 840 thereby extracts a feature amount in the entire long scene by inheriting the evaluation of the association degrees in the second target segment 820 by using a state transition in the time series direction, with an eigenvector having a high contribution ratio as an evaluation index. As a result, the association degree evaluation unit 150 obtains the effective index of the effective index extraction unit 840 as the evaluation index. The association degree evaluation unit 150 can evaluate the association degrees according to the transition state in the next segment, estimated from the association degree evaluation unit 150 in the previous segment.

The video processing apparatus 100 according to the present exemplary embodiment calculates an eigenvector having a high contribution ratio in each state during processing. However, such calculation may be performed state by state in advance. By calculating the contribution ratio of each state during processing, an eigenvector in a subsequent stage, such as a third target segment 830, can be adjusted to the current imaging environment. For example, differences of uniforms due to a team change and individual differences of the players can be reflected on the evaluation index.

The techniques described above in the first to third exemplary embodiments enable the visualization and provision of individual target objects according to the association degrees in a scene where a plurality of targets appear like a sport scene.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2017-181387, filed Sep. 21, 2017, which is hereby incorporated by reference herein in its entirety.

What is claimed is:

1. A video processing apparatus comprising:
an acquisition unit configured to acquire a video image;
an object extraction unit configured to extract a plurality of predetermined objects from the video image;
a selection unit configured to select a target object to be an observation target from the plurality of predetermined objects;
an evaluation unit configured to evaluate association about time and position information between the target object and an object other than the target object among the plurality of predetermined objects;
a determination unit configured to determine a display manner of the plurality of predetermined objects based on the association; and
a display unit configured to generate and display an image of the plurality of predetermined objects in the display manner.

2. The video processing apparatus according to claim 1, wherein the display unit is configured to generate an image by combining images of the plurality of predetermined objects at a plurality of points in time.

3. The video processing apparatus according to claim 1, wherein the display unit is configured to superimpose and display the combined image on an image of the video image at a predetermined point in time.

4. The video processing apparatus according to claim 1, wherein the determination unit is configured to determine the display manner of an object low in the association to be hidden.

5. The video processing apparatus according to claim 1, wherein the determination unit is configured to determine transparency as the display manner.

6. The video processing apparatus according to claim 1, wherein the determination unit is configured to determine a time interval between the plurality of points in time as the display manner.

7. The video processing apparatus according to claim 1, wherein the evaluation unit is configured to evaluate the association based on a distance, at a same time, between the target object and the object other than the target object among the predetermined objects.

8. The video processing apparatus according to claim 1, wherein the evaluation unit is configured to evaluate the association based on moving directions, in a same time period, of the target object and the object other than the target object among the predetermined objects.

9. The video processing apparatus according to claim 1,
wherein the extraction unit is configured to further extract a specific object, and
wherein the selection unit is configured to select the target object based on a relationship with the specific object.

10. The video processing apparatus according to claim 9, wherein the relationship is a positional relationship.

11. The video processing apparatus according to claim 9, wherein the relationship is a moving direction.

12. The video processing apparatus according to claim 1, wherein the object extraction unit is configured to set a segment region in a time direction of the plurality of predetermined objects from the acquired video image, and extract an area or layout of the target object from a video image of the set segment region.

13. The video processing apparatus according to claim 12, wherein the object extraction unit is configured to extract a temporal and spatial segment region in which the target object exists, from the acquired video image based on a frame in which the plurality of predetermined objects exists and a position and size of the target object in the frame.

14. The video processing apparatus according to claim 1, wherein the selection unit is configured to perform recognition processing on a specific action, select a target object closely associated with the specific action as an evaluation target from the plurality of predetermined objects based on a result of the recognition processing, and select a target object closely associated with an action of the evaluation target as a evaluated target.

15. The video processing apparatus according to claim 1, further comprising an evaluation index extraction unit configured to extract an evaluation index for evaluating the association,
wherein the evaluation unit is configured to evaluate the association based on the evaluation index.

16. The video processing apparatus according to claim 15, wherein the evaluation index extraction unit is configured to calculate motion directions of the evaluation target and the evaluated target in a target area frame by frame, and extract the evaluation index based on a motion direction feature amount obtained by tallying the motion directions into bins of a respective plurality of directions.

17. The video processing apparatus according to claim 16, wherein the evaluation index extraction unit is configured to extract a motion direction included in a common region common between the evaluation target and the evaluated target as the evaluation index, the common region being a high frequency region where the motion direction feature amount is greater than or equal to a predetermined threshold.

18. The video processing apparatus according to claim 16, wherein the evaluation index extraction unit is configured to calculate the motion directions of the evaluation target and the evaluated target in the target area frame by frame by offsetting the motion directions.

19. A video processing method comprising:
acquiring a video image;
extracting a plurality of predetermined objects from the video image;
selecting a target object to be an observation target from the plurality of predetermined objects;
evaluating association about time and position information between the target object and an object other than the target object among the plurality of predetermined objects;
determining a display manner of the plurality of predetermined objects based on the association; and
generating and displaying an image of the plurality of predetermined objects in the display manner.

20. A non-transitory computer-readable storage medium storing a program for causing a computer to function as:
an acquisition unit configured to acquire a video image;
an object extraction unit configured to extract a plurality of predetermined objects from the video image;
a selection unit configured to select a target object to be an observation target from the plurality of predetermined objects;
an evaluation unit configured to evaluate association about time and position information between the target object and an object other than the target object among the plurality of predetermined objects;
a determination unit configured to determine a display manner of the plurality of predetermined objects based on the association; and
a display unit configured to generate and display an image of the plurality of predetermined objects in the display manner.
